(19) United States
(12) Patent Application Publication
(10) Pub. No.: US 2008/0170314 A1
(43) Pub. Date: Jul. 17, 2008

(54) COLOR WHEEL ASSEMBLY

(76) Inventors: Kuang-Hua Chang, Taipei (TW); Chih-Huang Wang, Taipei County (TW); Ke-Shu Chin, Taipei County (TW); Chong-Han Tsai, Taipei County (TW); Kai Hsiung Tsao, Taipei (TW); Shiau-Wu Lai, Taipei County (TW)

Correspondence Address: BIRCH STEWART KOLASCH & BIRCH, PO BOX 747, FALLS CHURCH, VA, 22040-0747, US

(21) Appl. No.: 11/951,680

(22) Filed: Dec. 6, 2007

(30) Foreign Application Priority Data
Jan. 11, 2007 (TW) 096101074

(51) Int. Cl. G02B 7/00

(52) U.S. Cl. 359/892; 359/896

(57) ABSTRACT

A color wheel assembly includes a motor and a color filter. The motor has a main body and a housing. The housing is integrally formed and covers the main body. The color filter is disposed directly on the housing.

### CROSS REFERENCE TO RELATED APPLICATIONS

This Non-provisional application claims priority under 35 U.S.C. §119(a) on Patent Application No(s). 096101074 filed in Taiwan, Republic of China on Jan. 11, 2007, the entire contents of which are hereby incorporated by reference.

### BACKGROUND OF THE INVENTION

1. Field of Invention

The invention relates to a color wheel assembly and, in particular, to a color wheel assembly having a motor housing, which is integrally formed.

2. Related Art

As the progress of technology, the obstruction of scaled-up on the flat displays has been overcome. Large-sized flat displays have been utilized in household appliances gradually. Recently, users have paid more attention to one of the flat displays, the projector, which can achieve larger size and provide more concussive visual experience. The digital light processing (DLP) projector is one of the most popular projectors. DLP projector has the advantages of high brightness, fast response time, no noise, light and compact, so it has become the mainstream in the projection technologies.

In a DLP projector, a digital control method and a reflection principle are adopted. First, light beams are collimated, integrated by a lens and then pass through a color filter having RGB color filters. The light beams are then projected onto a digital micro-mirror device (DMD). In this technology, the liquid crystal panel of the traditional liquid crystal projector is replaced with the digital micro-mirror devices to display images. The digital micro-mirror device has several movable micro-mirrors. The driving electrodes may control the tilt angle and deflection time of each movable mirror, so that the light beams can be projected to form an image by switching the reflection directions of the light beams.

FIGS. 1A and 1B show the lateral sectional diagrams of a color wheel assembly 1, which is used in a conventional DLP projector. With reference to FIGS. 1A and 1B, the color wheel assembly 1 mainly includes a motor 11, a color filter 12, a cap 13, and a fixing element 14. The motor 11 is formed on the fixing element 14, and the cap 13 and the color filter 12 are fixed on the motor 11. The motor 11 is mainly composed of a shaft housing 111, a motor main body 112, and a motor shell 113. The motor main body 112 has a shaft 1121. Furthermore, the cap 13 can be formed on the color filter 12 (as shown in FIG. 1A) or be formed between the motor 11 and the color filter 12 (as shown in FIG. 1B).

As mentioned above, the color filter 12 can be carried by the cap 13 or be fixed on the motor 11 by the cap 13. Therefore, the cap 13 is necessary to combine the color filter 12 and the motor 11, and the shaft housing 111 and the motor shell 113 cover the motor main body 112 and the shaft 1121. Regarding to the manufacturing and assembling, more components lead to higher cost and more complex in product assembling.

Therefore, it is an important subjective to provide a color wheel assembly having less components and lower cost.

### SUMMARY OF THE INVENTION

In view of the foregoing, the invention is to provide a color wheel assembly having less components and lower cost.

To achieve the above, a color wheel assembly of the invention includes a motor and a color filter. The motor has a main body and a housing, which is integrally formed and covers the main body. The color filter is formed on the housing directly.

As mentioned above, the color wheel assembly of the invention includes a motor and a color filter. Compared with the related art, the color filter of the invention is directly disposed on the housing, which is integrally formed. The color wheel assembly is composed of the motor and the color filter and the conventional cap and shaft housing are unnecessary. Therefore, the amount of the components can be reduced, which can decrease the cost and facilitate the assembling. Furthermore, the housing of the invention further has a protrusion, which passes through the color filter to fix the color filter on the housing firmly. Moreover, the color wheel assembly of the invention further includes a ring disposed on the color filter for providing the counterweight during the calibration of rotating balance.

### BRIEF DESCRIPTION OF THE DRAWINGS

The invention will become more fully understood from the detailed description given herein below illustration only, and thus is not limitative of the present invention, and wherein:

FIG. 1A is a lateral sectional diagram of a conventional color wheel assembly;

FIG. 1B is a lateral sectional diagram of another conventional color wheel assembly;

FIG. 2 is a lateral sectional diagram of a color wheel assembly according to a preferred embodiment of the invention;

FIG. 3 is a lateral sectional diagram of another color wheel assembly according to the preferred embodiment of the invention; and

FIG. 4 is a lateral sectional diagram of still another color wheel assembly according to the preferred embodiment of the invention.

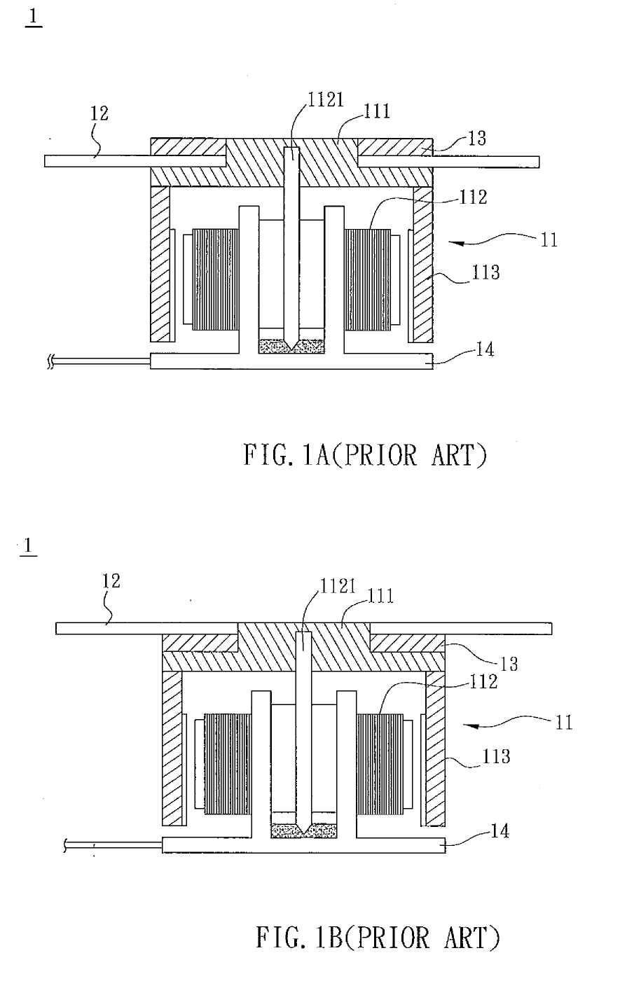

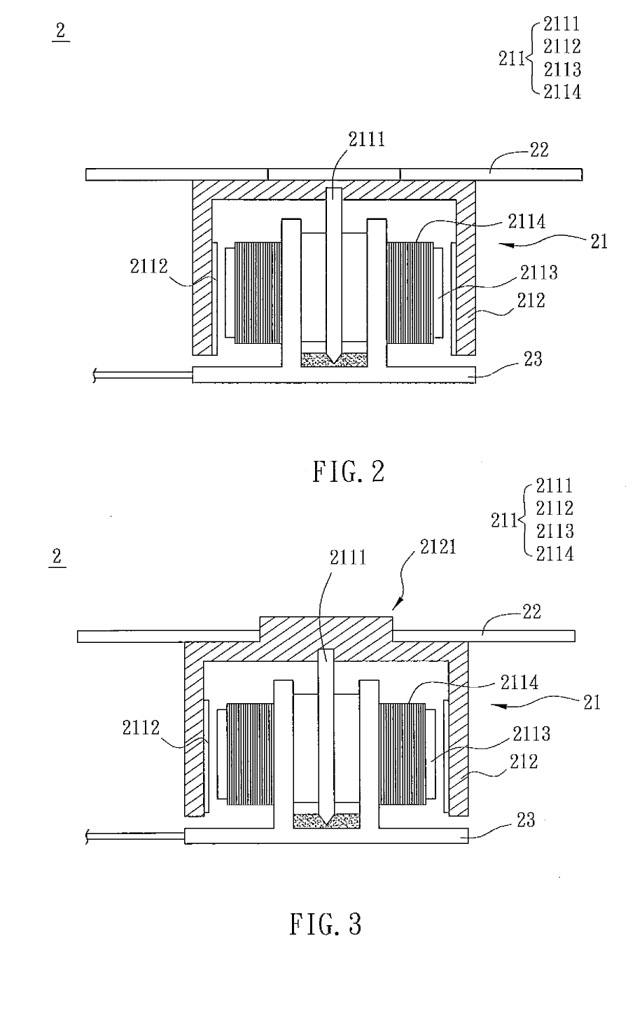

### DETAILED DESCRIPTION OF THE INVENTION

The present invention will be apparent from the following detailed description, which proceeds with reference to the accompanying drawings, wherein the same references relate to the same elements.

FIG. 2 is a lateral sectional diagram of a color wheel assembly 2 according to a preferred embodiment of the invention. Please refer FIG. 2, the color wheel assembly 2 includes a motor 21 and a color filter 22. In the embodiment, the color wheel assembly 2 can be applied to a DLP projector.

The motor 21 has a main body 211 and a housing 212. The color filter 22 is disposed on the motor 21 directly by, for example, adhering. The main body 211 of the motor 21 includes a shaft 2111, a magnetic ring 2112, a silicon steel slice 2113 and a coil 2114. When current passes through the coil 2114, the silicon steel slice 2113 produces a magnetic force to form a magnetic field. By converting the applied current, the magnetic field can be changed regularly so as to form a rotating magnetic field. The magnetic ring 2112 acts with the rotating magnetic field so as to drive the shaft 2111 to rotate.

The hosing 212 is integrally formed and covers the main body 211. The color filter 22 is directly disposed on the housing 212. In other words, the additional shaft housing is unnecessary in the housing 212 of the invention. In the embodiment, the housing 212 is integrally formed to cover the main body 211, so that the whole housing 212 becomes one part of the rotor. In addition, the housing 212 can be combined with the shift 2111 of the main body 211 by riveting, adhering or screwing. When the magnetic field induces the shift 2111 to rotate, the whole housing 212 can be driven to rotate.

In the embodiment, the color filter 22 is a ring-shaped filter and is a tricolor filter including a red area, a green area and a blue area. Alternatively, the color filter 22 can be a ring-shaped filter having a plurality of red areas, green areas and blue areas, or having a plurality of red areas, green areas, blue areas and transparent areas. Of course, the color filter 22 can be a ring-shaped transparent plate, which is coated the color filter 22 can be formed by a single glass plate coated with films or be composed of a plurality of glass plates.

In this embodiment, the color wheel assembly 2 further has a fixing element 23, and the motor 21 is shafted on the fixing element 23.

Referring to FIG. 3, the housing 212 of the embodiment further has a protrusion 2121, which passes through the color filter 22 to fix the color filter 22 on the housing 212. In the embodiment, the color filter 22 can be disposed on the housing 212 by adhering, wedging, screwing or hooking.

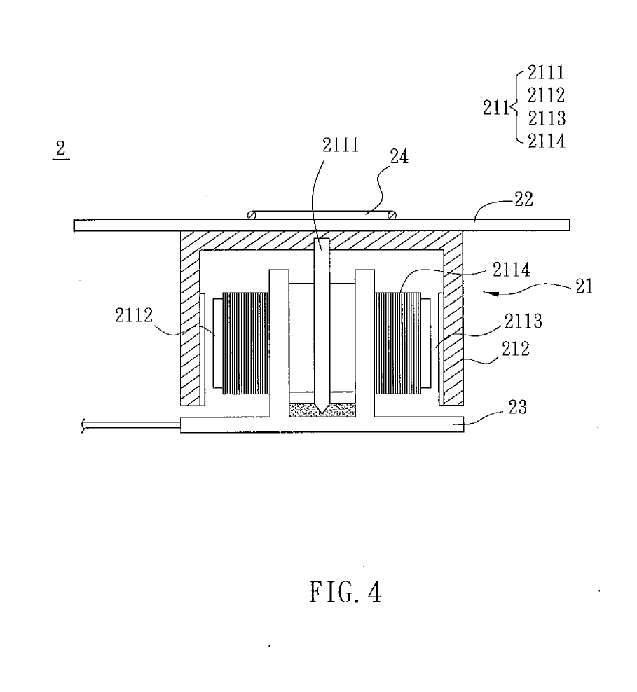

Please refer to FIG. 4, the color filter 22 of the embodiment is a disk-shaped filter, which is formed by a single glass coated with a film. In addition, the color wheel assembly 2 further has a ring 24 adhered to the color filter 22. The glue can be applied on the inner wall of the ring 24. Then, the applied glue can be used as the counterweight for calibrating the rotating balance of the color wheel assembly 2. The material of the ring 24 is, for example but not limited to, glass, metal (such as cooper), ceramics, or plastic. In addition, the height of the ring 24 is limited. In the embodiment, the ring 24 can be a metal sheet circled around the color filter 22.

As mentioned above, the color wheel assembly of the invention includes a motor and a color filter. Compared with the related art, the color filter of the invention is directly disposed on the housing, which is integrally formed. The color wheel assembly is composed of the motor and the color filter and the conventional cap and shaft housing are unnecessary. Therefore, the amount of the components can be reduced, which can decrease the cost and facilitate the assembling. Furthermore, the housing of the invention further has a protrusion, which passes through the color filter to fix the color filter on the housing firmly. Moreover, the color wheel assembly of the invention further includes a ring disposed on the color filter for providing the counterweight during the calibration of rotating balance.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A color wheel assembly, comprising:
a motor having a main body and a housing, the housing being integrally formed and covering the main body; and
a color filter disposed on the housing directly.

2. The color wheel assembly of claim 1, wherein the housing has a protrusion, and the protrusion passes through the color filter.

3. The color wheel assembly, further comprising:
a ring disposed on the color filter.

4. The color wheel assembly of claim 1, wherein the color filter and the housing are connected by adhering.

5. The color wheel assembly of claim 1, wherein the color filter and the housing are connected by wedging.

6. The color wheel assembly of claim 1, wherein the color filter and the housing are connected by hooking.

7. The color wheel assembly of claim 1, wherein the color filter is a ring-shaped filter or a disk-shaped filter.

8. The color wheel assembly of claim 1, wherein the color filter is formed by coating films on a glass plate.

9. The color wheel assembly of claim 1, wherein the color filter is made of a plurality of glass plates.

10. The color wheel assembly of claim 1 further comprising:
a fixing element, wherein the motor is shafted on the fixing element.
